(19) United States
(12) Patent Application Publication
(10) Pub. No.: US 2021/0379928 A1
(43) Pub. Date: Dec. 9, 2021

(54) OMNIDIRECTIONAL WHEEL AND MOVABLE DEVICE

(71) Applicant: HONGFUJIN PRECISION ELECTRONICS(TIANJIN)CO.,LTD., Tianjin (CN)

(72) Inventor: KE-CHENG LIN, New Taipei (TW)

(21) Appl. No.: 16/916,284

(22) Filed: Jun. 30, 2020

(30) Foreign Application Priority Data
Jun. 5, 2020 (CN) 202010504869.5

(51) Int. Cl. B60B 19/00; B60C 7/00

(52) U.S. Cl. CPC B60B 19/003; B60C 7/00

(57) ABSTRACT

An omnidirectional wheel includes a hub, a number of wheels, and a number of rubber covers. The hub defines a shaft hole passing through the hub. Each of the wheels is rotationally mounted on the hub and spaced around the shaft hole. Each of the rubber covers is sleeved on a corresponding one of the wheels and includes a three-dimensional pattern. The rubber covers prevent the hub from directly contacting the ground.

### FIELD

The subject matter herein generally relates to omnidirectional wheels and a movable device using the omnidirectional wheel.

### BACKGROUND

As shown in FIG. 1, an omnidirectional wheel in the related art includes a hub A and a wheel B rotationally mounted on the hub A. A gap H between the hub A and the ground is very small. If the ground is uneven, as long as the wheel is slightly inclined, a bottom of the hub may contact the ground and cause the omnidirectional wheel to be stuck and unable to move, as shown in FIG. 2.

### BRIEF DESCRIPTION OF THE DRAWINGS

Implementations of the present disclosure will now be described, by way of embodiments, with reference to the attached figures.

FIG. 1 is a schematic cross-sectional view of an omnidirectional wheel in the related art.

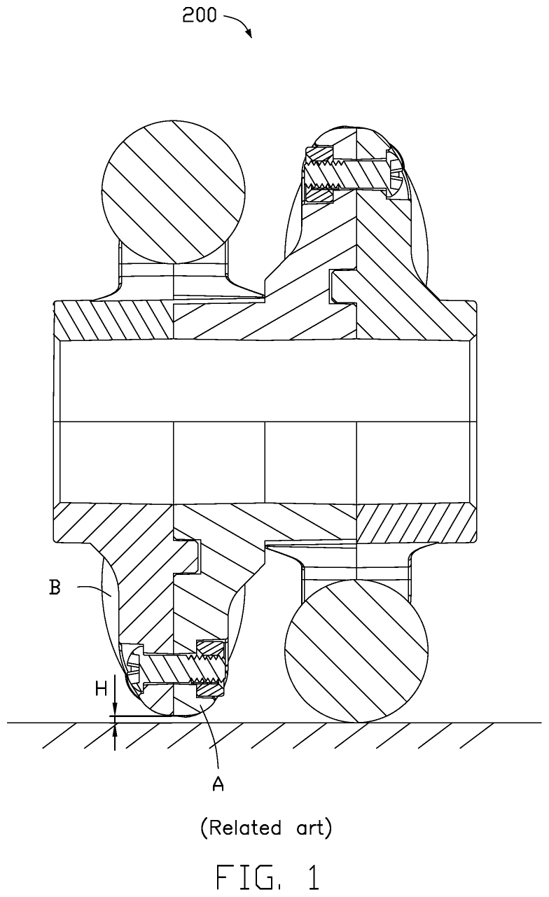

FIG. 2 is a schematic cross-sectional view of the omnidirectional wheel of FIG. 1 on an uneven ground.

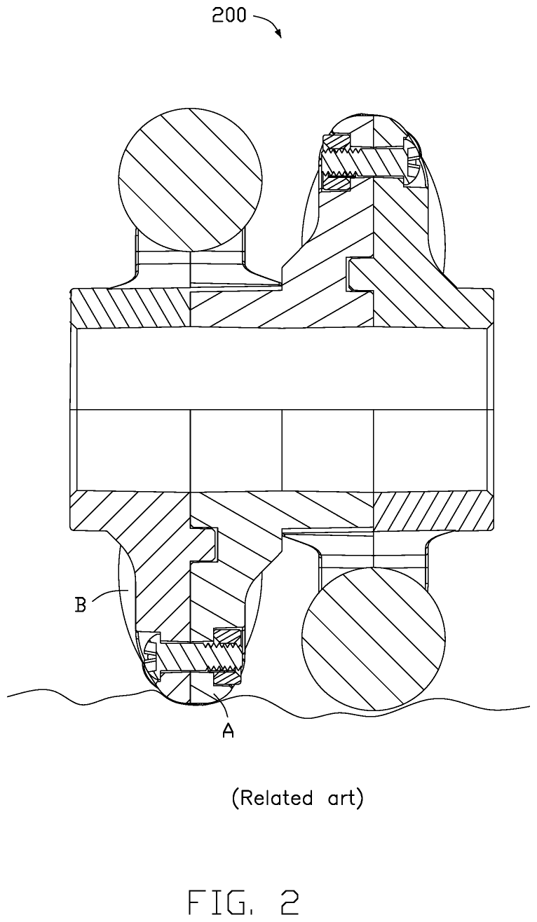

FIG. 3 is a perspective schematic view of an omnidirectional wheel according to an embodiment.

FIG. 4 is a perspective schematic view of a wheel and a rubber cover of the omnidirectional wheel.

FIG. 5 is a perspective schematic view of a hub of the omnidirectional wheel.

FIG. 6 is an exploded schematic view of the hub.

FIG. 7 is a schematic cross-sectional view of a gap between the hub and the ground.

FIG. 8 is a schematic plan view of the omnidirectional wheel.

FIG. 9 is a schematic diagram of the omnidirectional wheel on an uneven ground.

FIG. 10 is a schematic diagram of a movable device including the omnidirectional wheel.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

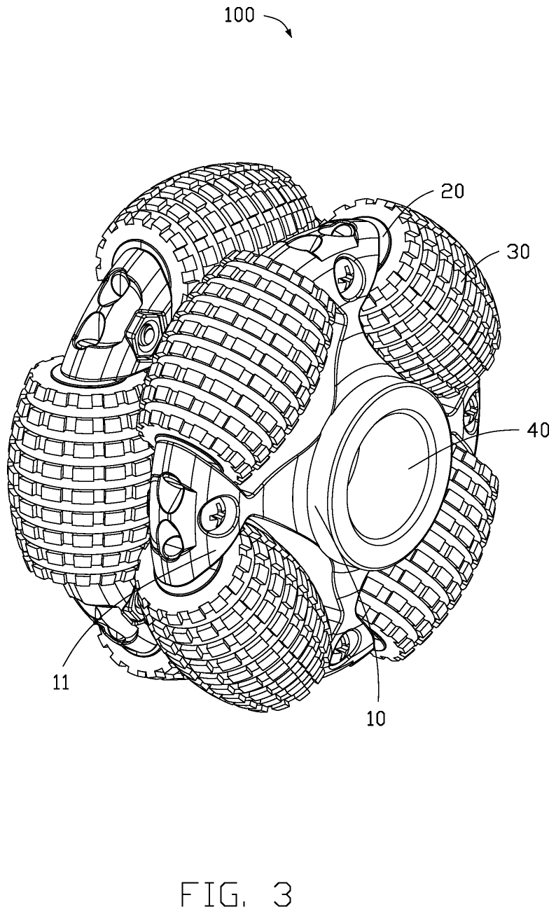

Referring to FIGS. 3, 4, and 5, an omnidirectional wheel 100 of the present disclosure includes a hub 10, a plurality of wheels 20, and a plurality of rubber covers 30. The hub 10 defines a shaft hole 40 penetrating through the hub 10. Each wheel 20 is rotationally disposed on the hub 10 and the plurality of wheels 20 are equally spaced around the shaft hole 40. Each of the rubber covers 30 is sleeved on a wheel 20, and the rubber cover 30 is provided with a three-dimensional pattern 50 for increasing friction. The rubber cover 30 is sleeved on the wheel 20 to prevent the hub 10 from directly contacting the ground when the omnidirectional wheel 100 is rolling on the ground.

In one embodiment, the rubber cover 30 provided with the three-dimensional pattern 50 is sleeved on the wheel 20, thereby effectively increasing the distance between the center of gravity of the wheel 20 and the ground, and also increasing the distance between the hub 10 and the ground to prevent the hub 10 from directly contacting the ground when the omnidirectional wheel 100 rolls on the ground (especially uneven ground). Furthermore, the rubber cover 30 increases friction between the wheel 20 and the ground to allow the omnidirectional wheel 100 to roll freely on the ground.

Further referring to FIG. 3, the plurality of wheels 20 forms two rings of wheels around the shaft hole 40. Each ring of wheels 20 includes a plurality of wheels 20, and the plurality of wheels 20 in each ring is spaced at intervals around the shaft hole 40. In one embodiment, the wheels 20 in the two rings of wheels 20 are offset around a periphery of the hub 10. In one embodiment, the number of wheels 20 in each ring of wheels 20 is four, but is not limited thereto.

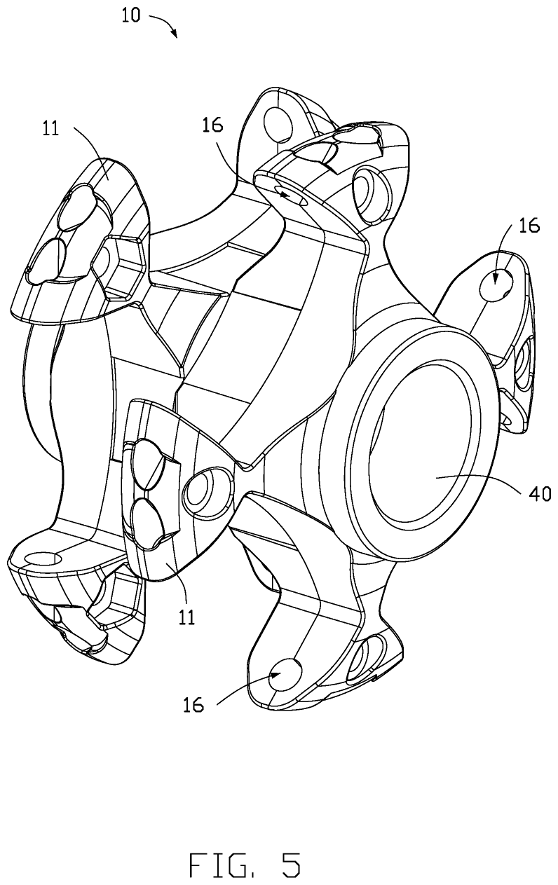

Referring to FIG. 5, the hub 10 includes a plurality of hub protrusions 11 that protrude outward and are spaced apart around the shaft hole 40. The plurality of hub protrusions 11 is formed as two rings around the shaft hole 40, and one wheel 20 is rotationally mounted between two adjacent hub protrusions 11 in the same ring. A thickness of the rubber cover 30 is set to prevent the hub protrusions 11 from directly contacting the ground.

In one embodiment, the hub protrusions 11 in both rings are offset from each other along a circumference of the hub 10. Each hub protrusion 11 of one ring directly faces one wheel 20 of the other ring.

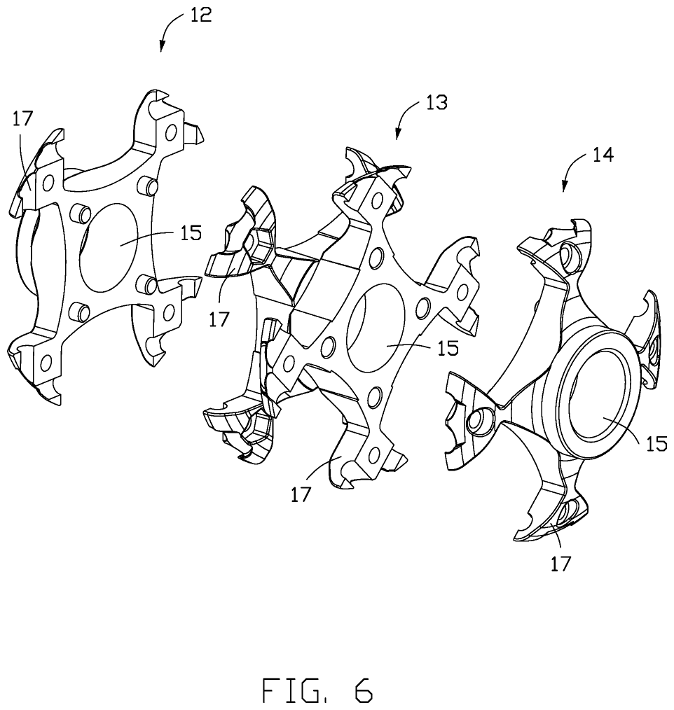

Referring to FIG. 6, the hub 10 includes a first side portion 12, a middle portion 13, and a second side portion 14 that are sequentially connected along an extending direction of the shaft hole 40. The first side portion 12, the middle portion 13, and the second side portion 14 are all provided with through holes 15. The through holes 15 of the first side portion 12, the middle portion 13, and the second side portion 14 cooperatively form the shaft hole 40. The first side portion 12 cooperates with the middle portion 13 to form a first ring of hub protrusions 11 for mounting one ring of wheels 20, and the second side portion 14 cooperates with the middle portion 13 to form a second ring of hub protrusion 11 for mounting a second ring of wheels 20.

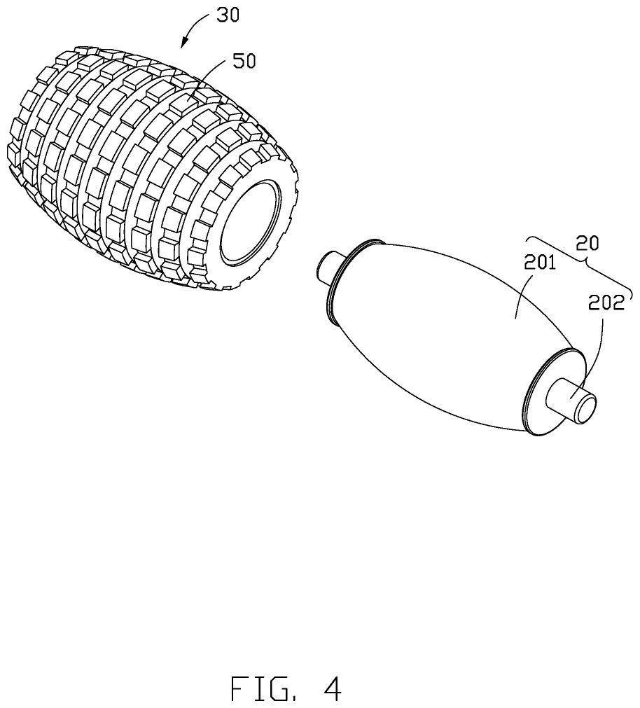

With further reference to FIGS. 3 and 4, each wheel 20 includes a main portion 201 and rotating shafts 202 protruding from opposite ends of the main portion 201. Each of the hub protrusions 11 defines a mounting hole 16 in each surface facing an adjacent hub protrusion 11 of the same ring. The rotating shafts 202 are rotationally received in the mounting holes 16 of two adjacent hub protrusions of the same ring, so that each wheel 20 is rotationally mounted between two adjacent hub protrusions 11 of the same ring.

In one embodiment, a cross-sectional diameter of the main portion 201 gradually decreases from a middle of the main portion 201 to the rotating shafts 202. A shape of the rubber cover 30 matches an outer contour of the main portion 201 to cover the main portion 201.

As shown in FIG. 6, the first side portion 12 includes a plurality of hub teeth 17 that protrude outward and are spaced apart around the through hole 15 of the first side portion 12. The second side portion 14 includes a plurality of hub teeth 17 protruding outward and spaced apart around the through hole 15 of the second side portion 14. The middle portion 13 includes a plurality of hub teeth 17 protruding outward and spaced apart around the through hole 15 of the middle portion 13. The plurality of hub teeth 17 of the middle portion 13 form two rings of hub teeth 17. Each ring of hub teeth 17 includes a plurality of hub teeth 17. The two rings of hub teeth 17 are offset from each other along a circumference of the hub 10.

In one embodiment, the plurality of hub teeth 17 of the first side portion 12 and the plurality of hub teeth 17 of a first ring of hub teeth 17 of the middle portion 13 are connected to each other one-to-one to form a first ring of hub protrusions 11, and the plurality of hub teeth 17 of the second side portion 14 and the plurality of hub teeth 17 of the second ring of hub teeth 17 of the middle portion 13 are connected to each other one-to-one to form a second ring of hub protrusions 11.

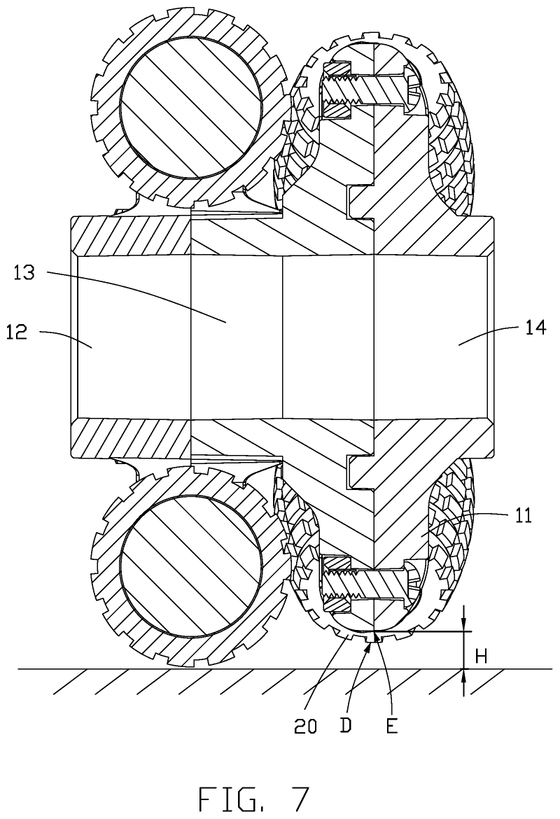

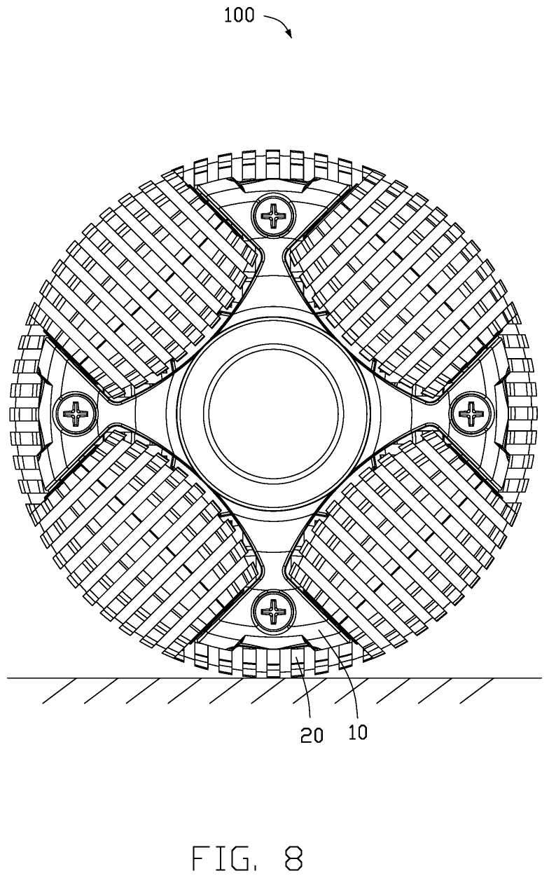

Referring to FIG. 7, after the rubber covers 30 with the three-dimensional pattern 50 are sleeved on the wheels 20, a diameter of the wheels 20 is effectively increased. When the omnidirectional wheel 100 slides on the ground, compared to the related art, a gap H between a bottom E of the hub protrusion 11 and the ground is increased, and a wheel surface D of the wheel 20 of a first ring is lower to the ground than the bottom E of the hub protrusion 11 of the second ring facing the wheel 20, as shown in FIG. 8.

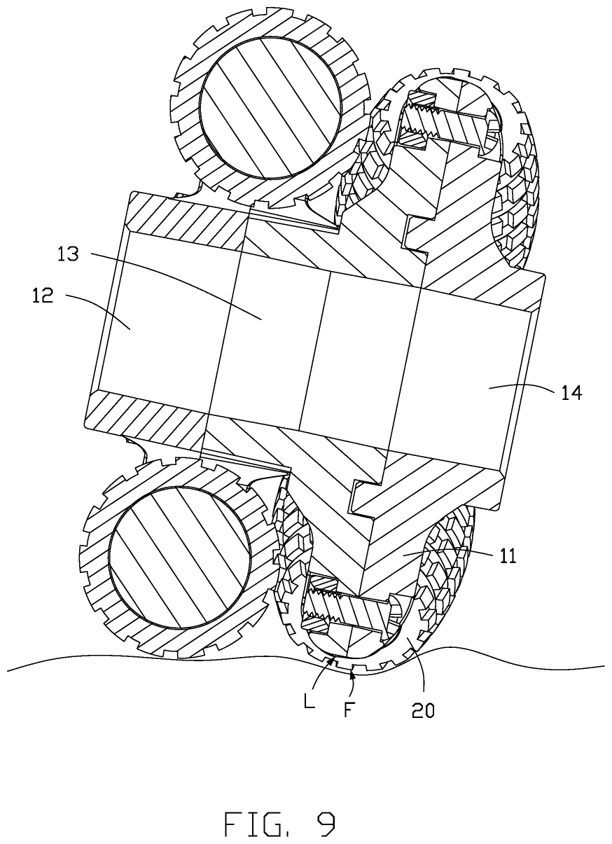

Referring to FIG. 9 (the curve in FIG. 9 represents an uneven ground), when the wheels 20 of the omnidirectional wheel 100 slide on an uneven ground, a contact surface F of the wheel 20 of the first ring is lower to the ground than a bottom L of the hub protrusion 11 of the second ring facing the wheel 20, so that the hub 10 does not directly contact the ground, and the omnidirectional wheel 100 does not slide on the uneven ground. Moreover, the rubber cover 30 with the three-dimensional pattern 50 is sleeved on the wheel 20 to enhance the friction of the wheel 20 on the ground, so that the omnidirectional wheel 100 can roll freely on the ground.

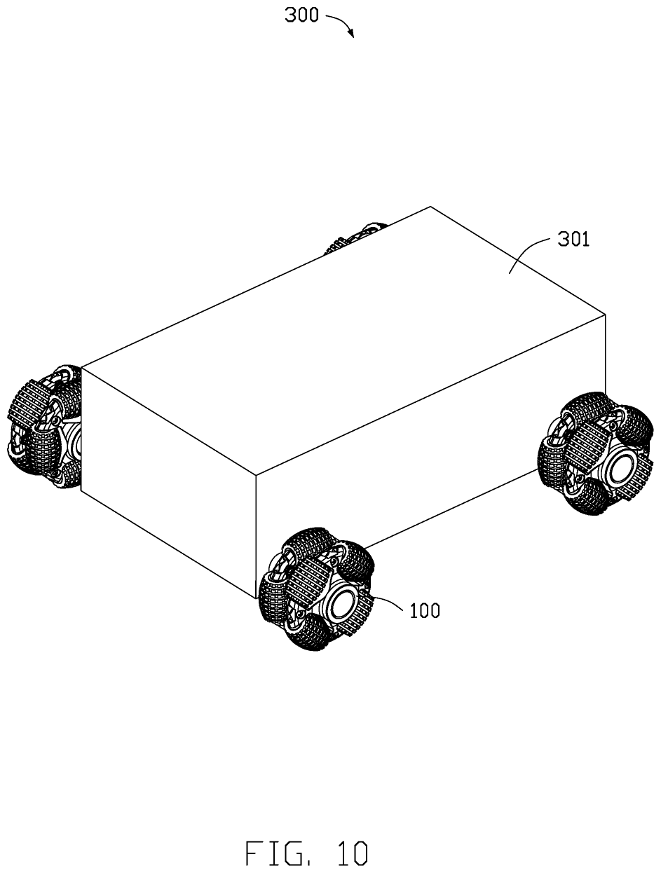

As shown in FIG. 10, an embodiment of the present disclosure further provides a movable device 300 using the omnidirectional wheel 100. The movable device 300 includes a body 301 and a plurality of the omnidirectional wheels 100 rotationally mounted on the body 301.

The movable device 300 may be a robot, a cart, a transfer conveyor, a freight car, a luggage case, etc.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An omnidirectional wheel comprising:
a hub defining a shaft hole passing through the hub;
a plurality of wheels each rotationally mounted on the hub and spaced around the shaft hole; and
a plurality of rubber covers each sleeved on a corresponding one of the plurality of wheels and comprising a three-dimensional pattern; wherein:
the rubber covers prevent the hub from directly contacting the ground.

2. The omnidirectional wheel of claim 1, wherein:
the plurality of wheels forms two rings of wheels around the shaft hole;
each ring of wheels comprises a plurality of wheels, and the plurality of wheels in each ring is spaced at intervals around the shaft hole.

3. The omnidirectional wheel of claim 2, wherein:
the wheels in the two rings of wheels are offset around a periphery of the hub.

4. The omnidirectional wheel of claim 3, wherein:
a number of the wheels in each of the two rings of wheels is equal.

5. The omnidirectional wheel of claim 2, wherein:
the hub comprises a plurality of hub protrusions that protrude outward and are spaced apart around the shaft hole;
the plurality of hub protrusions is formed as two rings around the shaft hole, and one wheel is rotationally mounted between two adjacent hub protrusions in the same ring;
a thickness of the rubber cover is set to prevent the hub protrusions from directly contacting the ground.

6. The omnidirectional wheel of claim 5, wherein:
the hub protrusions in both rings are offset from each other along a circumference of the hub; and
each hub protrusion of one ring directly faces one wheel mounted between two hub protrusions of the other ring.

7. The omnidirectional wheel of claim 5, wherein:
the hub comprises a first side portion, a middle portion, and a second side portion that are sequentially coupled along an extending direction of the shaft hole;
the first side portion, the middle portion, and the second side portion are all provided with through holes;
the through holes of the first side portion, the middle portion, and the second side portion cooperatively form the shaft hole;
the first side portion cooperates with the middle portion to form a first ring of hub protrusions for mounting one ring of wheels, and the second side portion cooperates with the middle portion to form a second ring of hub protrusion for mounting a second ring of wheels.

8. The omnidirectional wheel of claim 5, wherein:
each wheel comprises a main portion and rotating shafts protruding from opposite ends of the main portion;
each of the hub protrusions defines a mounting hole in each surface facing an adjacent hub protrusion of the same ring; and
the rotating shafts are rotationally received in the mounting holes of two adjacent hub protrusions of the same ring.

9. The omnidirectional wheel of claim 8, wherein:
a cross-sectional diameter of the main portion gradually decreases from a middle of the main portion to the rotating shafts; and
a shape of the rubber cover matches an outer contour of the main portion to cover the main portion.

10. A movable device comprising:
a body; and
a plurality of omnidirectional wheels, the omnidirectional wheel comprising:
a hub defining a shaft hole passing through the hub;
a plurality of wheels each rotationally mounted on the hub and spaced around the shaft hole; and
a plurality of rubber covers each sleeved on a corresponding one of the plurality of wheels and comprising a three-dimensional pattern; wherein:
the rubber covers prevent the hub from directly contacting the ground.

11. The movable device of claim 10, wherein:
the plurality of wheels forms two rings of wheels around the shaft hole;
each ring of wheels comprises a plurality of wheels, and the plurality of wheels in each ring is spaced at intervals around the shaft hole.

12. The movable device of claim 11, wherein:
the wheels in the two rings of wheels are offset around a periphery of the hub.

13. The movable device of claim 12, wherein:
a number of the wheels in each of the two rings of wheels is equal.

14. The movable device of claim 11, wherein:
the hub comprises a plurality of hub protrusions that protrude outward and are spaced apart around the shaft hole;
the plurality of hub protrusions is formed as two rings around the shaft hole, and one wheel is rotationally mounted between two adjacent hub protrusions in the same ring;
a thickness of the rubber cover is set to prevent the hub protrusions from directly contacting the ground.

15. The movable device of claim 14, wherein:
the hub protrusions in both rings are offset from each other along a circumference of the hub; and
each hub protrusion of one ring directly faces one wheel mounted between two hub protrusions of the other ring.

16. The movable device of claim 14, wherein:
the hub comprises a first side portion, a middle portion, and a second side portion that are sequentially coupled along an extending direction of the shaft hole;
the first side portion, the middle portion, and the second side portion are all provided with through holes;
the through holes of the first side portion, the middle portion, and the second side portion cooperatively form the shaft hole;
the first side portion cooperates with the middle portion to form a first ring of hub protrusions for mounting one ring of wheels, and the second side portion cooperates with the middle portion to form a second ring of hub protrusion for mounting a second ring of wheels.

17. The movable device of claim 14, wherein:
each wheel comprises a main portion and rotating shafts protruding from opposite ends of the main portion;
each of the hub protrusions defines a mounting hole in each surface facing an adjacent hub protrusion of the same ring; and
the rotating shafts are rotationally received in the mounting holes of two adjacent hub protrusions of the same ring.

18. The movable device of claim 17, wherein:
a cross-sectional diameter of the main portion gradually decreases from a middle of the main portion to the rotating shafts; and
a shape of the rubber cover matches an outer contour of the main portion to cover the main portion.
